(19) United States
(12) Patent Application Publication
(10) Pub. No.: US 2018/0115206 A1
(43) Pub. Date: Apr. 26, 2018

(54) ELECTRIC MOTOR ELEMENT, ELECTRIC MOTOR, AND DEVICE

(71) Applicant: Panasonic Intellectual Property Management Co., Lt, Osaka (JP)

(72) Inventors: YUSUKE OKUMURA, Osaka (JP); YUICHI YOSHIKAWA, Osaka (JP); HARUHIKO KADO, Osaka (JP); YUKIHIRO OKADA, Osaka (JP); SHIZUKA YOKOTE, Osaka (JP); TAKASHI OGAWA, Osaka (JP)

(21) Appl. No.: 15/562,879

(22) PCT Filed: Sep. 27, 2016
(86) PCT No.: PCT/JP2016/004348

§ 371 Date: Sep. 28, 2017

(30) Foreign Application Priority Data
Oct. 1, 2015 (JP) 2015-195519

(51) Int. Cl. H02K 1/27; H02K 1/02; H02K 1/16; H02K 3/02; H02K 3/12; H02K 3/28; H02K 21/14; H02K 15/03; H01F 1/053; H01B 1/02

(52) U.S. Cl. CPC H02K 1/2766; H02K 1/02; H02K 1/16; H02K 3/02; H02K 3/12; H02K 2201/12; H02K 21/14; H02K 15/03; H01F 1/053; H01B 1/026; H01B 1/023; H02K 3/28

(57) ABSTRACT

An electric motor element according to the present invention includes a rotor. The rotor includes a rotor core constituted by a plurality of punched steel sheets laminated in a rotational shaft direction, magnet positioning holes penetrating the rotor core, and a bonded magnet portion constituting a permanent magnet. The magnet positioning holes are filled with the bonded magnet portion. A length of the rotor core in the rotational shaft direction is larger than a length of a stator core in the rotational shaft direction. The bonded magnet portion is shaped such that a position of the bonded magnet portion, the position being located between both axial ends of the rotor and in a plane facing the stator core, is closer to a rotation shaft holding the rotor, than to a position of the bonded magnet portion, the position being located at one of the axial ends of the rotor in the rotational shaft direction and in the plane facing the stator core.

### TECHNICAL FIELD

The present invention relates to an electric motor element which includes an interior permanent magnet rotor containing a plurality of permanent magnets inside a rotor core at predetermined intervals, and further relates to an electric motor including this electric motor element, and a device including this electric motor.

### BACKGROUND ART

A conventional electric motor element equipped with permanent magnets includes a rotor disposed on an inner circumferential side of a stator with a gap left between the rotor and the stator.

The stator is substantially cylindrical, and generates a rotating magnetic field.

The rotor includes a shaft and a rotor core. A magnetic pole of the rotor is formed by permanent magnets embedded in the rotor core. The rotor rotates around the shaft.

The rotor is constituted by the rotor core and the permanent magnets. More specifically, the rotor core is a lamination body formed by laminating thin plate-shaped magnetic steel sheets. The permanent magnets are disposed in magnet positioning holes formed in the lamination body. Fragments of the permanent magnets and the like are inserted into the magnet positioning holes.

An electric motor element which includes permanent magnets embedded in a rotor core similarly to the configuration described above is also called an interior permanent magnet (IPM) type electric motor element.

An interior permanent magnet rotor is widely used for a following reason.

A rotor including permanent magnets in a rotor core exhibits magnetic saliency. When a rotor has magnetic saliency, rotation torque generated from the rotor contains reluctance torque as well as magnet torque.

For example, a material widely adopted for constituting permanent magnets includes fragments of Nd—Fe—B family sintered magnets, and fragments of ferrite sintered magnets.

For using fragments of permanent magnets, each of magnet positioning holes formed in a rotor core is sized to be slightly larger than an external shape of each of the permanent magnets. Work efficiency for assembling the rotor improves when each of the magnet positioning holes is sized to be slightly larger than the external shape of each of the permanent magnets. This improvement in work efficiency comes from following reasons.

The magnet positioning holes formed in the core of the rotor are produced by processing metal. A step for processing metal is hereinafter referred to as a metal processing step. The magnet positioning holes accurately processed in this manner have smaller dimensional tolerance.

On the other hand, the fragments of the permanent magnets described above are produced by sintering magnet powder or the like. A step for sintering magnet powder or the like is hereinafter referred to as a sintering step. The sintering step is similar to a step for baking pottery and porcelain or the like in a kiln. Accordingly, deformation such as a warp and a bend may be produced in sintered fragments of permanent magnets. The deformation produced in the fragments of the permanent magnets is removable by grinding with a grindstone and the like. A step for grinding with a grindstone and the like is hereinafter referred to as a grinding step.

However, the grinding step is not generally adopted for removal of deformation produced in fragments of permanent magnets included in an electric motor element. Even if the grinding step is performed for an electric motor element, only a small amount of grinding is removable from the fragments of the permanent magnets. Moreover, grinding accuracy of the fragments of the permanent magnets is insufficient.

Accordingly, deformation produced in fragments of permanent magnets of an electric motor element is generally treated by increasing the size of the magnet positioning holes to a length slightly larger than the external shape of the fragments of the permanent magnets as described above. When the grinding step is adopted, following problems may arise. The problems are, for example, a necessity of equipment for grinding, and increase in the number of working steps.

However, when the size of the magnet positioning holes is slightly larger than the external shape of the fragments of the permanent magnets, a gap is produced between a rotor core and the fragments of the permanent magnets. This gap produced between the rotor core and the fragments of the permanent magnets causes magnetic resistance. Accordingly, a magnetic flux density in a surface of the rotor decreases.

On the other hand, fragments of permanent magnets made of Nd—Fe—B family sintered magnets or ferrite sintered magnets, for example, have characteristic of hardness and fragileness, similarly to pottery and porcelain. Accordingly, fragments of permanent magnets are difficult to process into complicated shapes.

More specifically, following shapes are adopted for fragments of permanent magnets. For example, each of fragments of the permanent magnets is constituted by a columnar body having a rectangular cross-sectional shape. The columnar body having a rectangular cross-sectional shape is a flat plate body. Alternatively, each of fragments of the permanent magnets is constituted by a columnar body having a trapezoidal cross-sectional shape. Alternatively, each of fragments of the permanent magnets is constituted by a columnar body having a circular-arc cross-sectional shape. The columnar body having a circular-arc cross-sectional shape is a plate body having a substantially U-shaped cross-sectional shape.

Each of the fragments of the permanent magnets produced by the foregoing forming steps has large dimensional tolerance. Accordingly, a gap is produced between a rotor core and the fragments of the permanent magnets thus produced.

For handling this gap, PTL 1 discloses an interior permanent magnet rotor manufactured by inserting fragments of permanent magnets having a high energy density into magnet positioning holes, and subsequently filling the magnet positioning holes with mixtures constituting bonded magnets. The mixtures constituting bonded magnets enter the gap between the fragments of permanent magnets and the magnet positioning holes in the interior permanent magnet rotor. The mixtures constituting bonded magnets having entered the gap cancel magnetic resistance caused by the gap. Accordingly, a magnetic flux density generated by the interior permanent magnet rotor improves.

Each of relative permeability of an Nd—Fe—B family sintered magnet and relative permeability of a ferrite sintered magnet is substantially equivalent to relative permeability of air. Each of these values of relative permeability is slightly larger than 1.0. Similarly, each of relative permeability of a bonded magnet containing powder of an Nd—Fe—B family sintered magnet and relative permeability of a bonded magnet containing powder of a ferrite sintered magnet is substantially equivalent to relative permeability of air. Each of these values of relative permeability is also slightly larger than 1.0.

In other words, each of a bonded magnet containing powder of an Nd—Fe—B family sintered magnet and a bonded magnet containing powder of a ferrite sintered magnet is equivalent to a layer of air. Accordingly, a magnetic flux density generated by an interior permanent magnet rotor is not expected to improve even when the gap between fragments of permanent magnets and magnet positioning holes is filled with a bonded magnet of the types described above.

In addition, a mixture having entered the gap between fragments of permanent magnets and magnet positioning holes has a small thickness. Even when a mixture constituting a bonded magnet is magnetized in a direction of this small thickness, a magnetic force generated from the mixture is small. This limitation comes from a large effect exerted by a diamagnetic field on the mixture constituting the bonded magnet. Accordingly, a magnetic force of the mixture having entered the gap between the fragments of the permanent magnets and the magnet positioning holes does not considerably contribute to improvement of a magnetic flux density generated by an interior permanent magnet rotor.

When a bonded magnet or a bonded magnetic body having relative permeability larger than relative permeability of air is used, a magnetic flux density generated by an interior permanent magnet rotor is expected to improve. A bonded magnet or a bonded magnet body is hereinafter collectively referred to as a bonded magnet or the like. According to the foregoing configuration, however, magnetic saturation of a bonded magnet or the like may be caused by a magnetic field coming from the outside or a magnetic field coming from a fragment of a permanent magnet. Under magnetic saturation of a bonded magnet or the like, relative permeability of the bonded magnet or the like decreases to a value close to relative permeability of air. As a result, the foregoing configuration comes into a state equivalent to a state including a layer of air. In this case, a magnetic flux density generated by an interior permanent magnet rotor is not expected to improve.

Note that a substance having a high saturation flux density, and larger relative permeability than relative permeability of air is considered as a useful material for a bonded magnet material.

There is presented no description about relative permeability of a bonded magnet or permeability of a bonded magnet in PTL 1.

Needless to say, it is essential to check relative permeability of a bonded magnet or the like, or an effect of magnetic saturation or a diamagnetic field when a bonded magnet or the like is adopted.

On the other hand, there has been proposed a configuration capable of increasing rotation torque of an interior permanent magnet (IPM) electric motor element. According to this configuration, a rotor core overhangs a stator core in a rotational shaft direction such that a lamination thickness of the rotor core becomes larger than a lamination thickness of the stator core (e.g. PTL 2).

It is apparent that the technology according to PTL 2 or the like is adoptable to the technology according to PTL 1 or the like to provide an interior permanent magnet (IPM) electric motor which includes bonded magnets. The electric motor thus provided includes a rotor core overhanging a stator core in such a condition that a lamination thickness of the rotor core becomes larger than a lamination thickness of the stator core. Accordingly, rotation torque increases.

However, this configuration is not yet capable of solving following problems. As described in PTL 2 or the like, effective magnetic flux increases by increasing an axial length of the rotor core to a length larger than an axial length of a stator. However, when a size of an overhang portion or an effective size of the overhang portion reaches a certain length, an increase in ineffective components constituted by magnetic flux not reaching the stator from the rotor (leakage magnetic flux) overwhelms the increase in the effective magnetic flux. In this case, the increase in the size of the overhang portion or the effective size of the overhang portion does not contribute to the increase in the amount of the effective magnetic flux. In other words, a relationship between the size of the overhang portion or the effective size of the overhang portion and the amount of the effective magnetic flux does not become correlative, but exhibits a saturation curve. In addition, even when the size of the overhang portion or the effective size of the overhang portion is excessively enlarged, rises of output and torque of an electric motor element are limited. Accordingly, remarkable effects are difficult to produce.

### CITATION LIST

### Patent Literature

PTL 1: Unexamined Japanese Patent Publication No. 10-304610
PTL 2: Unexamined Japanese Patent Publication No. 2006-211801

### SUMMARY OF THE INVENTION

An electric motor element according to an aspect of the present invention comprises at least a stator and a rotor. The rotor includes a configuration that has magnetic saliency. The configuration that has magnetic saliency includes a plurality of d-axis flux paths through each of which magnet torque passes, the magnet torque being contained in rotation torque components generated by a rotating magnetic field coming from the stator, and a plurality of q-axis flux paths through each of which reluctance torque passes, the reluctance torque being contained in the rotation torque components. At least a part of each of the d-axis flux paths includes a bonded magnet portion. At least a part of each of the q-axis flux paths includes an adjacent portion brought into contact with the bonded magnet portion. A constituent element of the bonded magnet portion includes at least magnet powder and resin material, and a close contact portion at which the bonded magnet portion and a peripheral portion of the bonded magnet portion are brought into close contact with each other. A length of a rotor core in a rotational shaft direction is larger than a length of a stator core in the rotational shaft direction. The bonded magnet portions is shaped such that a position of the bonded magnet portion, the position being located between both axial ends of the rotor and in a plane facing the stator core, is closer to a rotation shaft of the rotor than to a position of the bonded magnet portion, the position being located at one of the axial ends of the rotor in the rotational shaft direction and in the plane facing the stator core, is to the rotation shaft.

In the electric motor element of the present invention, a cross-sectional shape of the bonded magnet portion in the rotational shaft direction includes a V shape formed such that a central portion of the bonded magnet portion between both end faces in the rotational shaft direction protrudes toward the rotation shaft of the rotor.

In the electric motor element of the present invention, a cross-sectional shape of the bonded magnet portion in the rotational shaft direction includes a circular-arc shape formed such that a central portion of the bonded magnet portion between both end faces in the rotational shaft direction protrudes toward the rotation shaft of the rotor.

In the electric motor element of the present invention, a cross-sectional shape of the bonded magnet portion in the rotational shaft direction includes a short-side shape of a trapezoid formed such that a central portion of the bonded magnet portion between both end faces in the rotational shaft direction protrudes toward the rotation shaft of the rotor.

In the electric motor element of the present invention, the bonded magnet portion of the rotor includes a skew configuration.

In the electric motor element of the present invention, the resin material of the constituent element of the bonded magnet portion includes thermoplastic resin and/or thermosetting resin.

In the electric motor element of the present invention, the magnet powder of the constituent element of the bonded magnet portion includes rare earth magnet powder.

In the electric motor element of the present invention, the magnet powder of the constituent element of the bonded magnet portion includes Nd—Fe—B family magnet powder.

In the electric motor element of the present invention, a constituent element of the close contact portion brought into close contact with the bonded magnet portion includes at least one of a ferromagnetic substance, a paramagnetic substance, and a diamagnetic substance.

In the electric motor element of the present invention, a constituent element of the close contact portion brought into close contact with the bonded magnet portion includes at least a magnetic steel sheet lamination body.

In the electric motor element of the present invention, a magnetic steel sheet is included in both constituent elements of the stator, and constituent elements of the rotor.

In the electric motor element of the present invention, a constituent element of the stator core includes an annular connection body that includes a plurality of segment cores.

In the electric motor element of the present invention, stator wirings of the stator include wirings formed by concentrated wiring.

In the electric motor element of the present invention, stator wirings of the stator include wirings formed by distributed wiring.

In the electric motor element of the present invention, stator wirings of the stator include wirings formed by wave wiring.

In the electric motor element of the present invention, stator wirings of the stator include insulated wires. A material of cores of the insulated wires includes inevitable impurities, and any one of copper, copper alloy, aluminum, or aluminum alloy.

In the electric motor element of the present invention, a content of magnet powder contained in the bonded magnet falls within a range from 93% by weight to 97% by weight.

An electric motor according to another aspect of the present invention comprises the electric motor element described above.

A device according to a further aspect of the present invention comprises an electric motor that includes the electric motor element described above.

The present invention offers advantages of reducing leakage magnetic flux from a radial surface of an overhanging rotor core which protrudes from a stator core in a rotational shaft direction, and increasing magnetic flux flowing toward a stator to increase an effective flux amount contributing to torque.

### BRIEF DESCRIPTION OF DRAWINGS

FIG. 1 is a cross-sectional view of an electric motor element according to a first exemplary embodiment of the present invention, illustrating a cross section perpendicular to a rotational shaft of the electric motor element.

FIG. 2 is a schematic view of the electric motor element according to the first exemplary embodiment of the present invention.

FIG. 3 is a partial cross-sectional view of an electric motor element according to example 1 of the present invention.

FIG. 4 is a graph showing a change of a flux amount relative to a change of an overhang length of a rotor core.

FIG. 5A is a partial cross-sectional view of an electric motor element according to example 2 of the present invention.

FIG. 5B is a partial cross-sectional view of an electric motor element according to example 3 of the present invention.

FIG. 5C is a partial cross-sectional view of an electric motor element according to example 4 of the present invention.

FIG. 5D is a partial cross-sectional view of an electric motor element according to example 5 of the present invention.

FIG. 6 is a schematic view illustrating a configuration of an air cleaner presented by way of example of a device according to a second exemplary embodiment of the present invention.

FIG. 7 is a partial cross-sectional view of a conventional interior permanent magnet type electric motor element.

### DESCRIPTION OF EMBODIMENTS

Exemplary embodiments and examples according to the present invention are hereinafter described with reference to the drawings. The present invention is not limited to the embodiments and examples presented herein.

### First Exemplary Embodiment

### (Magnet Powder)

A magnetic material of magnet powder adopted in the present invention is not limited to a particular type. For example, the magnetic material is selected from Nd—Fe—B family magnet powder, Sm—Co family magnet powder, Sm—Fe—N family magnet powder, ferrite family magnet powder, and a mixture of these types of powder.

Rare earth family magnet powder is preferable for an electric motor element according to the present invention among the types of magnet powder described above.

For improving magnetic characteristics, Nd—Fe—B family magnet powder is particularly preferable.

Note that each of Nd—Fe—B family magnet powder, Sm—Co family magnet powder, Sm—Fe—N family magnet powder, and ferrite family magnet powder contains scandium (Sc), yttrium (Y), and lanthanide elements belonging to the Group III in the long-periodic table. The lanthanide elements include lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), and lutetium (Lu), for example. The powder contains at least one or two types of these elements.

Heat resistance of magnet powder further increases when magnet powder is coated with heat resisting coating beforehand. A heat resisting coating layer adopted in the present invention is not particularly limited. It is preferable, however, that the coating layer is made of phosphate compound.

According to the present invention, a preferable result is obtained without problems when a content of rare earth family magnet powder of a bonded magnet falls within a range from 93% by weight to 97% by weight with respect to a whole bonded magnet in a kneading step. On the other hand, problems arise when a content of rare earth family magnet powder exceeds 97% by weight, or reaches 98% by weight with respect to a whole bonded magnet in a kneading step. A kneading temperature in a kneading step is set to a temperature appropriate for a type of resin contained in a bonded magnet. For example, a kneading temperature for polyamide 6 resin is approximately 250° C. On the other hand, a kneading temperature for polyphenylene sulfide resin is approximately 310° C.

It has been confirmed that a density of a bonded magnet compact lies in a range from approximately 5.4 Mg/m3 to 6.5 Mg/m3 when a content of rare family magnet powder is in a range from 93% by weight to 97% by weight with respect to a whole bonded magnet.

Moreover, a density of a bonded magnet compact may be further raised by several percent by performing an additional step for a produced compact, such as re-pressurization a several number of times, integration of pressurizing methods, and readjustment of molding temperature at the time of re-pressurization, as well as an ordinary resin molding step adopted for the present invention. The bonded magnet having a raised density in this manner obtains high-performance magnetic characteristics, and allows a rotor of an electric motor element to provide desired performance according to the present invention.

### (Other Additives)

A compound for a bonded magnet may contain an antioxidant, a heavy metal deactivator, a plasticizer, a denaturant, or other additives.

### (Manufacturing Method of Electric Motor Element)

Magnet powder coated with weather resistance coating beforehand is mixed with lubricant capable of achieving condensation-reaction with a magnet powder outermost layer. Thermoplastic resin is subsequently added to the mixture of the magnet powder and lubricant. The resultant mixture is loaded into a kneading extruder, a kneader or the like heated to a high temperature to be kneaded. A kneaded material thus obtained is processed into a pellet form by using a pelletizer to produce a pellet of a bonded magnet compound.

Magnet positioning holes of a rotor of an electric motor element is filled with a melt of the bonded magnet compound described above by using an injection molding machine or a transfer molding machine, for example, to produce an electric motor element including bonded magnets as constituent elements.

It is particularly preferable that each bonded magnet portion is configured to be brought into contact with a structure including at least any one of a ferromagnetic substance, a paramagnetic substance, and a diamagnetic substance in a direction of magnetic flux of the bonded magnet portion to realize an effective action of magnetic force from the bonded magnet without losses.

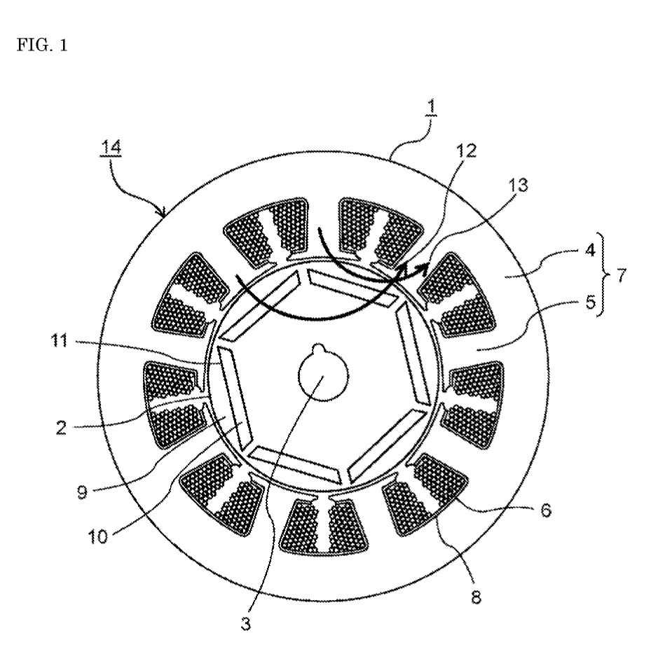

FIG. 1 is a cross-sectional view illustrating a structure example of the electric motor element according to the present invention. A configuration of so-called 6-pole 9-slot concentrated winding is adopted for a combination of respective numbers of poles and slots of the electric motor element illustrated in FIG. 1. More specifically, the electric motor element has a stator including concentrated winding bodies wound around nine teeth, and a rotor including six magnetic poles having magnetic saliency.

The configuration of the electric motor element according to the present invention is not limited to the configuration described above. While FIG. 1 illustrates winding bodies 6 each of which is a body of concentrated winding constituted by windings wound around single tooth 5 by way of example, the present invention is not limited to this example. Various types of winding are adoptable, such as distributed winding constituted by windings wound around a plurality of teeth 5, and wave winding.

The electric motor element according to the present invention is applicable to any one of known combinations of respective numbers of poles and slots, such as a configuration of 10-pole 9-slot concentrated winding, a configuration of 10-pole 12-slot concentrated winding, a configuration of 12-pole 9-slot concentrated winding, a configuration of 14-pole 12-slot concentrated winding, a configuration of 4-pole 24-slot distributed winding, a configuration of 4-pole 36-slot distributed winding, a configuration of 6-pole 36-slot distributed winding, a configuration of 8-pole 48-slot distributed winding, a configuration of 4-pole 12-slot wave winding, a configuration of 4-pole 12-slot wave winding, and a configuration of 6-pole 18-slot wave winding.

As illustrated in FIG. 1, electric motor element 14 according to this exemplary embodiment includes substantially cylindrical stator 1, and rotor 2 rotatably held inside stator 1. Shaft hole 3 is formed at a center of rotor 2. Rotor 2 and a shaft (not shown) are fixed to each other in a state that the shaft is inserted into shaft hole 3. A pair of bearings are provided at both ends of the shaft to support the shaft such that the shaft is rotatable. FIG. 1 does not show the shaft and the bearings which are well-known components.

Stator 1 includes core 7 and winding bodies 6. Core 7 includes substantially cylindrical yoke 4, and teeth 5 extending from an inner side of yoke 4. Each of winding bodies 6 includes insulated wires wound around corresponding tooth 5. Insulators 8 are provided between teeth 5 and winding bodies 6 to electrically insulate teeth 5 and winding body 6 from each other. On the other hand, rotor 2 includes cylindrical rotor core 9 and bonded magnet portions 10. Each of bonded magnet portions 10 is disposed in corresponding one of a plurality of (six in this exemplary embodiment) magnet positioning holes 11 formed in rotor 2 in a circumferential direction.

Cores of the insulated wires constituting winding bodies 6 are made of a material containing inevitable impurities, and any one of copper, copper alloy, aluminum, or aluminum alloy.

Each of bonded magnet portions 10 contains at least magnet powder and resin material. Types of a magnetic material of the magnet powder are not particularly limited. For example, the magnetic material is appropriately selected from Nd—Fe—B family magnet powder, Sm—Co family magnet powder, Sm—Fe—N family magnet powder, ferrite family magnet powder, and a mixture of these types of powder. A cross-sectional shape of each of bonded magnet portions 10 taken in a direction perpendicular to an axial direction is selected from shapes suitable for specifications, such as a substantially circular-arc shape, a rectangular shape, a trapezoidal shape, and a V shape.

Rotor 2 of electric motor element 14 according to the present invention has magnetic saliency. More specifically, as illustrated in FIG. 1, a portion of rotor 2 indicated by transverse arrow 12 corresponds to a d-axis flux path forming portion, and generates magnet torque of rotation torque components generated in accordance with a rotating magnetic field coming from stator 1. On the other hand, a portion of the rotor indicated by transverse arrow 13 corresponds to a q-axis flux path forming portion, and generates reluctance torque of the rotation torque components generated in accordance with the rotating magnetic field coming from stator 1.

According to electric motor element 14 manufactured by the method described above, magnet positioning holes 11 are filled with the bonded magnets held by the core corresponding to core 9. Accordingly, rigidity of electric motor element 14 increases, while size variations and strength deterioration of the bonded magnets decrease.

More detailed configurations of electric motor element 14 according to the first exemplary embodiment of the present invention are hereinafter described with reference to the drawings.

### EXAMPLE 1

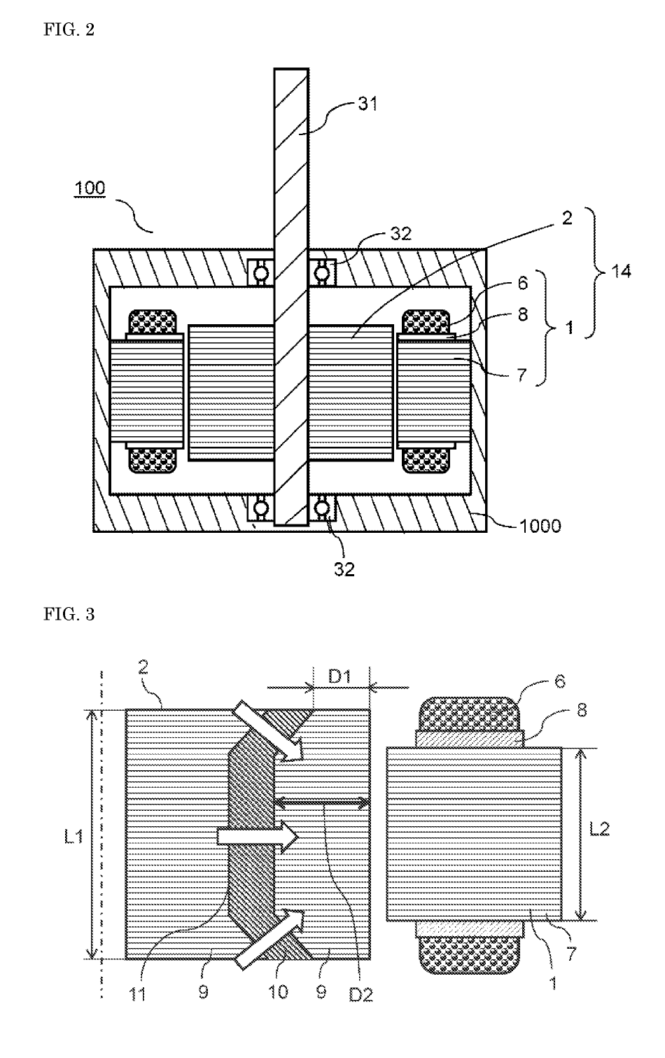

FIG. 2 is a cross-sectional view of electric motor element 14 according to the first exemplary embodiment of the present invention, illustrating a plane containing a center axis of a rotation shaft of electric motor element 14 to show a configuration of electric motor 100 including electric motor element 14. White bold arrows shown in each of FIGS. 2, 5A, 5B, 5C, 5D, and 6 schematically indicates magnetic flux generated from the bonded magnet portion. A chain line in each of these figures indicates a center line of the rotation shaft of the rotor.

As illustrated in FIG. 2, electric motor element 14 is constituted by stator 1 and rotor 2. Stator 1 includes stator core 7, and winding bodies 6 each of which is constituted by stator windings and wound around stator core 7 via insulator 8. Rotor 2 is disposed inside stator core 7 with a small gap left between rotor 2 and stator core 7. Shaft 31 is fixed to a center of rotor 2. Shaft 31 is rotatably held by two bearings 32. FIG. 2 also illustrates external casing 1000 of electric motor element 14 according to the present example. A structure and a material of external casing 1000 are appropriately selected in accordance with specifications of electric motor element 14. For example, the material of external casing 1000 is generally selected from a resin material, a metal material and the like. The structure of external casing 1000 is selected from various types such as an integrally molded body, a casting body made of metal, and a metal plate molded body. Bearings 32 are appropriately selected from various types, such as ball bearings and oil-retaining bearings, in accordance with specifications of the electric motor element.

According to electric motor 100 presented in this exemplary embodiment by way of example and illustrated in FIG. 2, electric motor element 14 is accommodated in external casing 1000 in a state that shaft 31 is fixed to rotor 2 of electric motor element 14 and held by two bearings 32.

FIG. 3 is a partial cross-sectional view of rotor 2 according to example 1 of this exemplary embodiment. Rotor 2 is constituted by rotor core 9, magnet positioning hole 11, and bonded magnet portion 10. Rotor core 9 is constituted by a plurality of punched steel sheets laminated in a rotational shaft direction. Magnet positioning hole 11 penetrates rotor core 9. Magnet positioning hole 11 is filled with bonded magnet portion 10 constituted by a permanent magnet.

A mode of electric motor element 14 according to the present example includes a following configuration. A length of rotor core 9 in the rotational shaft direction is larger than a length of stator core 7 in the rotational shaft direction. In addition, a position of bonded magnet portion 10 in the vicinity of a central portion between axial ends of rotor 2 in the rotational direction and in a plane facing stator core 7 is located closer to the rotational shaft of rotor 2 than to a position of bonded magnet portion 10 at one of the axial ends of rotor 2 in the rotational shaft direction.

More specifically, as illustrated in FIG. 3, a length (L1) of rotor core 9 in the rotational shaft direction is larger than a length (L2) of stator core 7 in the rotational shaft direction. In addition, a position of bonded magnet portion 10 in a plane facing stator core 7 in the vicinity of the central portion between the axial ends in the axial direction of rotor 2 (position at rotational shaft side end of dimension D2 in FIG. 3) is located closer to the rotational shaft of rotor 2 than to a position of bonded magnet portion 10 in the plane facing stator core 7 at one of the axial ends in the rotational shaft direction of rotor 2 (position at rotational shaft side end of dimension D1 in FIG. 3).

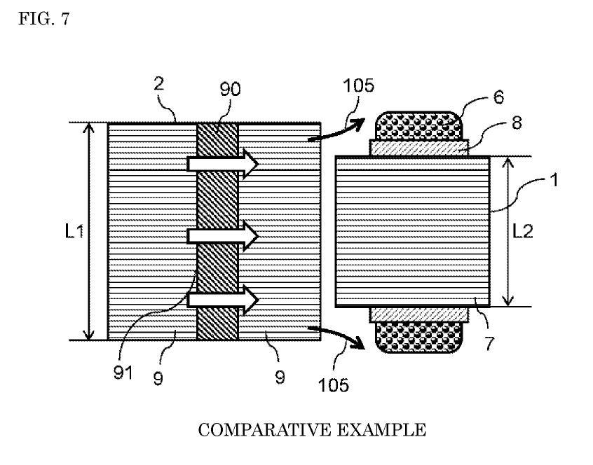

FIG. 7 is a view illustrating a comparative example of a typical conventional configuration presented for comparison.

The comparative example illustrated in FIG. 7 is different from the present example illustrated in FIG. 3 only in a structure of magnet positioning hole 91 formed in rotor 2, and bonded magnet portion 90 inserted into magnet positioning hole 91. As illustrated in a partial cross-sectional view of an interior permanent magnet rotor in FIG. 7, magnetic flux generated from bonded magnet portion 90 leaks into air from a radial surface of rotor core 9 protruded from stator core 7 as schematically indicated by arrows 105 in FIG. 7 when the rotor core only extends from (overhangs) the stator core in the rotational shaft direction in excess of a length of the stator core in the rotational shaft direction. This flux leakage reduces a total amount of magnetic flux flowing toward the stator, thereby preventing an effective rise of an effective flux amount contributing to torque.

On the other hand, according to rotor 2 of the present example illustrated in FIG. 3, magnet positioning hole 11 is inclined to an in-plane direction of rotor core 9. In this case, magnetic flux concentrates on the central portion of rotor core 9. This configuration therefore decreases a flux amount leaking into air from a radial surface of rotor core 9 protruding from stator core 7 in the rotational shaft direction.

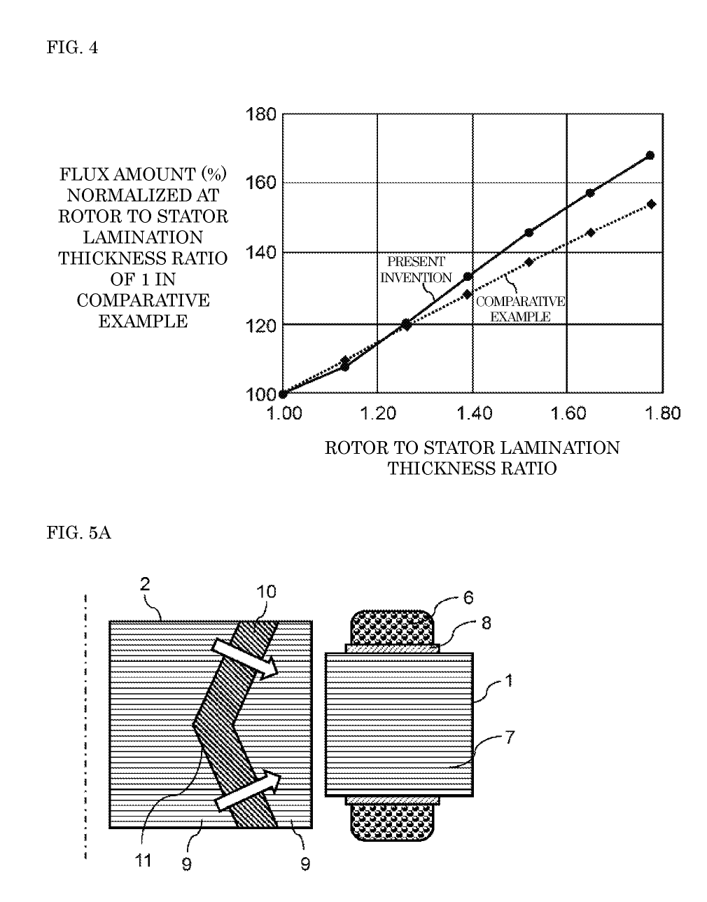

For confirming this effect, numerical analysis of a magnetic field was conducted by using a finite element method. FIG. 4 shows a calculation result of a flux amount flowing in the stator core in a state of the overhanging rotor core in each of the present example and the comparative example illustrated in FIG. 7. As apparent from FIG. 4, rotor core 9 of electric motor element 14 illustrated in FIGS. 2 and 3 according to the present invention generates a larger flux amount flowing in stator core 7 than that amount of overhanging rotor core 9 of the electric motor element illustrated in FIG. 7 in the comparative example. It is also obvious that the excess of the flux amount of the present invention from that amount of the comparative example increases as the overhanging volume of rotor core 9 becomes larger.

FIG. 4 shows the calculation results on the assumption that lengths of the rotor core and stator core in the rotational shaft direction are substantially equivalent to lengths of the rotor core and stator core in a radial direction, respectively, at a ratio close to 1. Even when the lengths of the rotor core and stator core in the rotational shaft direction are larger than the lengths of the rotor core and stator core in the radial direction, respectively, at a ratio larger than 1, similar useful results are obtainable. This configuration is not detailed herein.

In another mode of the present example which includes rotor core 9 overhanging stator core 7 only on at least one side of rotor core 9 in FIG. 3, a substantially similar effect is obtained. Accordingly, a substantially similar effect is obtainable when magnet positioning hole 11 is configured such that magnetic flux generated from bonded magnet portion 10 converges on substantially the central portion of stator core 7 between both end faces in the rotational shaft direction.

While the inner rotor type configuration which positions rotor core 9 inside stator core 7 is adopted in the present example, an outer rotor type configuration which positions rotor core 9 outside stator core 7 may be adopted.

In addition, rotor core 9 may be formed by rotational lamination to skew bonded magnet portion 10 with respect to the rotational shaft direction.

### EXAMPLE 2

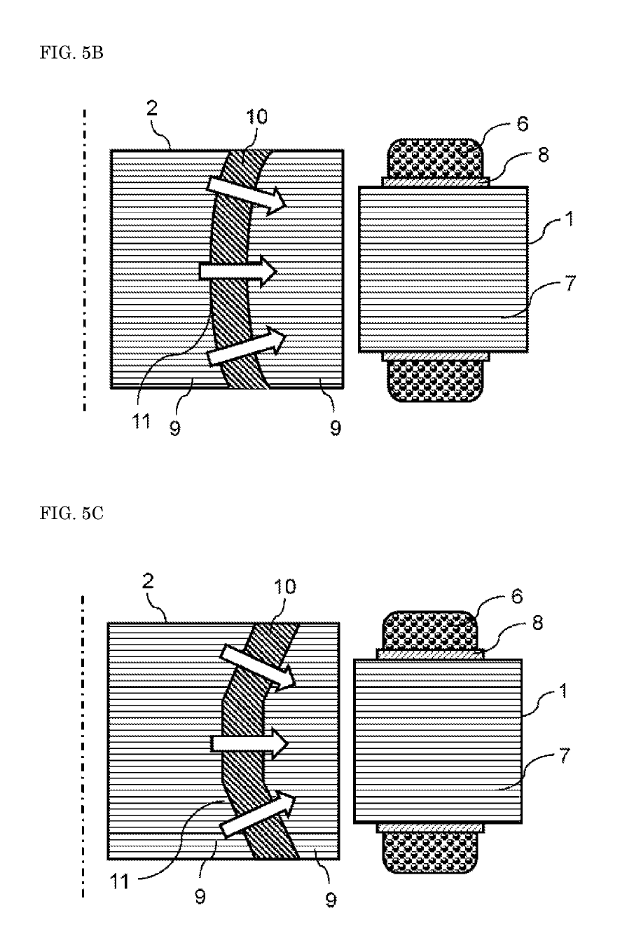

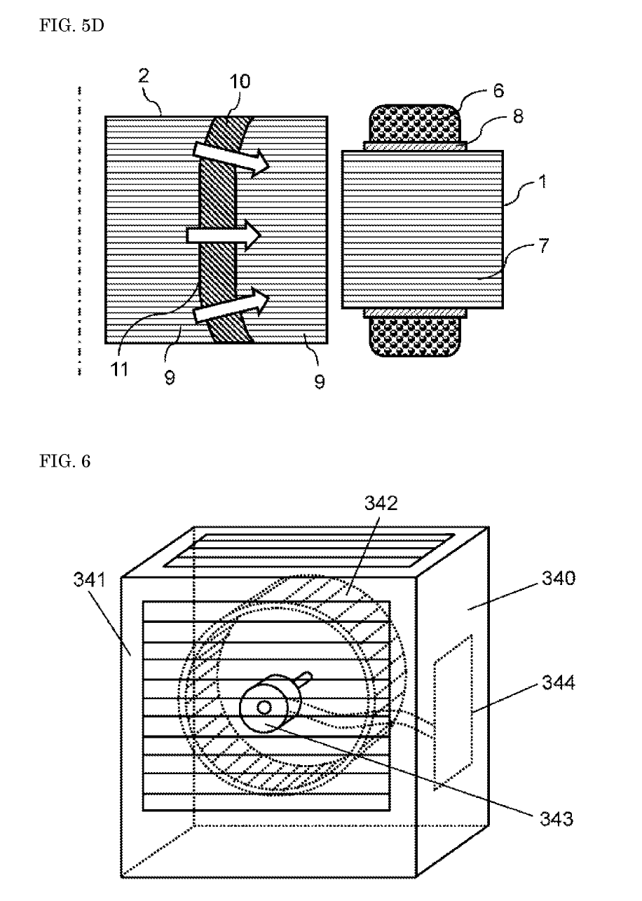

FIG. 5A is a partial cross-sectional view of rotor 2 according to example 2 of the present invention. Configurations similar to the corresponding configurations in example 1 are given identical reference numbers, and the same description of these configurations is not repeated.

This example in FIG. 5A is different from example 1 in that magnet positioning hole 11 formed in rotor 2 has a V-shaped cross section parallel with the rotational shaft direction. More specifically, the cross section of bonded magnet portion 10 in the rotational shaft direction is shaped such that the central portion of bonded magnet portion 10 between both end faces in the rotational shaft direction has a V shape protruding toward the rotational shaft which holds rotor 2. According to this configuration, magnetic flux generated from bonded magnet portion 10 inserted into magnet positioning hole 11 and hardened in magnet positioning hole 11 similarly converges on the central portion of rotor core 9. Accordingly, an effect similar to the effect of example 1 is offered.

### EXAMPLE 3

FIG. 5B is a partial cross-sectional view of rotor 2 according to example 3 of the present invention. Configurations similar to the corresponding configurations in example 1 are given identical reference numbers, and the same description of these configurations is not repeated.

This example in FIG. 5B is different from example 1 in that magnet positioning hole 11 formed in rotor 2 has a circular-arc-shaped cross section parallel with the rotational shaft direction. More specifically, the cross section of bonded magnet portion 10 in the rotational shaft direction is shaped such that the central portion of bonded magnet portion 10 between both the end faces in the rotational shaft direction has a circular-arc shape protruding toward the rotational shaft which holds the rotor. According to this configuration, magnetic flux generated from bonded magnet portion 10 inserted into magnet positioning hole 11 and hardened in magnet positioning hole 11 similarly converges on the central portion of rotor core 9. Accordingly, an effect similar to the effect of example 1 is offered.

### EXAMPLE 4

FIG. 5C is a partial cross-sectional view of rotor 2 according to example 4 of the present invention. Configurations similar to the corresponding configurations in example 1 are given identical reference numbers, and the same description of these configurations is not repeated.

This example in FIG. 5C is different from example 1 in that magnet positioning hole 11 formed in rotor 2 has a linear cross section parallel with the rotational shaft direction in a shape extending along a line parallel with the rotational shaft direction, in addition to a substantially V shape. More specifically, the cross section of bonded magnet portion 10 in the rotational shaft direction is shaped such that the central portion of bonded magnet portion 10 between both the end faces in the rotational shaft direction has a short-side shape of a trapezoid protruding toward the rotational shaft which holds the rotor. According to this configuration, magnetic flux generated from bonded magnet portion 10 inserted into magnet positioning hole 11 and hardened in magnet positioning hole 11 similarly converges on the central portion of rotor core 9. Accordingly, an effect similar to the effect of example 1 is offered.

### EXAMPLE 5

FIG. 5D is a partial cross-sectional view of rotor 2 according to example 5 of the present invention. Configurations similar to the corresponding configurations in example 1 are given identical reference numbers, and the same description of these configurations is not repeated.

This example in FIG. 5D is different from example 1 in that magnet positioning hole 11 formed in rotor 2 has a circular-arc-shaped cross section parallel with the rotational shaft direction, and a linear cross section parallel with the rotational shaft direction in a shape extending along a line parallel with the rotational shaft direction. More specifically, the cross section of bonded magnet portion 10 in the rotational shaft direction is shaped such that the central portion of bonded magnet portion 10 between both the end faces in the rotational shaft direction has a shape similar to a short-side shape of a trapezoid protruding toward the rotational shaft which holds the rotor. This example is different from example 4 in that parts of bonded magnet portion 10 in the vicinity of both the end faces in the rotational shaft direction are not linear but circular-arc-shaped or curved. The circular-arc shape or curved shape may be either a convex or a concave with respect to an outer circumference of the rotor, or may have a composite curve including a convex or concave shape with respect to the outer circumference of the rotor. The circular-arc shape or curved shape therefore may be any shapes as long as desired specifications of the electric motor element are obtained. According to this configuration, magnetic flux generated from bonded magnet portion 10 inserted into magnet positioning hole 11 and hardened in magnet positioning hole 11 similarly converges on the central portion of rotor core 9. Accordingly, an effect similar to the effect of example 1 is obtained.

As described above, according to the present invention, ineffective magnetic flux not flowing from the rotor to the stator (leakage flux) does not increase even when the rotor core overhangs the stator core such that the lamination thickness of the rotor core becomes larger than the lamination thickness stator core. Accordingly, the electric motor element provided herein has a novel configuration capable of raising output and torque of the electric motor element.

### Second Exemplary Embodiment

Hereinafter described in detail is a configuration of an air cleaner presented by way of example of an electric device including the electric motor according to the present invention. As illustrated in FIG. 6, electric motor 343 is provided in housing 341 of air cleaner 340. Air circulation fan 342 is attached to a rotational shaft of electric motor 343. Electric motor 343 is driven by electric motor driving device 344.

Electric motor 343 rotates in response to energization from electric motor driving device 344. Fan 342 rotates in accordance with rotation of electric motor 343. Air is circulated by rotation of fan 342. Electric motor 343 may be constituted by electric motor 100 including electric motor element 14 described in the first exemplary embodiment, for example.

### INDUSTRIAL APPLICABILITY

An electric motor element according to the present invention is capable of reducing leakage magnetic flux from a radial surface of an overhanging rotor core which protrudes from a stator core, and increasing magnetic flux flowing toward a stator to increase an effective flux amount contributing to torque. Accordingly, the electric motor element according to the present invention is applicable to a wide variety of electric devices including an electric motor element.

### REFERENCE MARKS IN THE DRAWINGS

1: stator

2: rotor

3: shaft hole

4: yoke

5: tooth

6: winding body

7: stator core

8: insulator

9: rotor core

10, 90: bonded magnet portion

11, 91: magnet positioning hole

12, 13, 104, 105: arrow

14: electric motor element

31: shaft

32: bearing

100: electric motor

340: air cleaner

341: housing

342: fan

343: electric motor

344: electric motor driving device

1000: external casing

1. An electric motor element comprising
at least a stator and a rotor,
wherein
the rotor includes a configuration that has magnetic saliency,
the configuration that has the magnetic saliency includes a plurality of d-axis flux paths through each of which magnet torque passes, the magnet torque being contained in rotation torque components generated by a rotating magnetic field coming from the stator, and a plurality of q-axis flux paths through each of which reluctance torque passes, the reluctance torque being contained in the rotation torque components,
at least a part of each of the d-axis flux paths includes a bonded magnet portion,
at least a part of each of the q-axis flux paths includes an adjacent portion brought into contact with the bonded magnet portion,
a constituent element of the bonded magnet portion includes magnet powder and a resin material, and a close contact portion at which the bonded magnet portion and a peripheral portion of the bonded magnet portion are brought into close contact with each other,
a length of a rotor core in a rotational shaft direction is larger than a length of a stator core in the rotational shaft direction, and
the bonded magnet portion is shaped such that a position of the bonded magnet portion, the position being located between both axial ends of the rotor and in a plane facing the stator core, is closer to a rotation shaft of the rotor than to a position of the bonded magnet portion, the position being located at one of the axial ends of the rotor in the rotational shaft direction and in the plane facing the stator core.

2. The electric motor element according to claim 1, wherein
a cross-sectional shape of the bonded magnet portion in the rotational shaft direction includes a V shape formed such that a central portion of the bonded magnet portion between both end faces in the rotational shaft direction protrudes toward the rotation shaft of the rotor.

3. The electric motor element according to claim 1, wherein
a cross-sectional shape of the bonded magnet portion in the rotational shaft direction includes a circular-arc shape formed such that a central portion of the bonded magnet portion between both end faces in the rotational shaft direction protrudes toward the rotation shaft of the rotor.

4. The electric motor element according to claim 1, wherein
a cross-sectional shape of the bonded magnet portion in the rotational shaft direction includes a short-side shape of a trapezoid formed such that a central portion of the bonded magnet portion between both end faces in the rotational shaft direction protrudes toward the rotation shaft of the rotor.

5. The electric motor element according to claim 1, wherein
the bonded magnet portion of the rotor includes a skew configuration.

6. The electric motor element according to claim 1, wherein
the resin material of the constituent element of the bonded magnet portion includes either thermoplastic resin or thermosetting resin.

7. The electric motor element according to claim 1, wherein
the magnet powder of the constituent element of the bonded magnet portion includes rare earth magnet powder.

8. The electric motor element according to claim 1, wherein
the magnet powder of the constituent element of the bonded magnet portion includes Nd—Fe—B family magnet powder.

9. The electric motor element according to claim 1, wherein
a constituent element of the close contact portion brought into close contact with the bonded magnet portion includes any one of a ferromagnetic substance, a paramagnetic substance, and a diamagnetic substance.

10. The electric motor element according to claim 1, wherein
a constituent element of the close contact portion brought into close contact with the bonded magnet portion includes at least a magnetic steel sheet lamination body.

11. The electric motor element according to claim 1, wherein
a magnetic steel sheet is included in both constituent elements of the stator, and constituent elements of the rotor.

12. The electric motor element according to claim 1, wherein
a constituent element of the stator core includes an annular connection body that includes a plurality of segment cores.

13. The electric motor element according to claim 1, wherein
stator wirings of the stator include wirings formed by concentrated wiring.

14. The electric motor element according to claim 1, wherein
stator wirings of the stator include wirings formed by distributed wiring.

15. The electric motor element according to claim 1, wherein
stator wirings of the stator include wirings formed by wave wiring.

16. The electric motor element according to claim 1, wherein
stator wirings of the stator include insulated wires, and
a material of cores of the insulated wires includes inevitable impurities, and any one of copper, copper alloy, aluminum, or aluminum alloy.

17. The electric motor element according to claim 1, wherein
a content of the magnet powder contained in the bonded magnet falls within a range from 93% by weight to 97% by weight.

18. An electric motor comprising
the electric motor element according to claim 1.

19. A device comprising
an electric motor that includes the electric motor element according to claim 1.
